(19) United States
(12) Patent Application Publication
(10) Pub. No.: US 2026/0296047 A1
(43) Pub. Date: Oct. 1, 2026

(54) METHOD AND SYSTEM FOR DETECTING INK BATCHES THAT DEGRADE PRINT QUALITY IN INKJET PRINTING

(71) Applicant: Xerox Corporation, Norwalk, CT (US)

(72) Inventors: Christine A. Steurrys, Williamson, NY (US); James E. Baxter, Canandaigua, NY (US); Stuart A. Schweid, Pittsford, NY (US); Jason Matthew Lefevre, Penfield, NY (US)

(21) Appl. No.: 19/090,707

(22) Filed: Mar. 26, 2025

(51) Int. Cl. B41J 2/195; B41J 2/165; B41J 2/175; B41J 29/393

(52) U.S. Cl. CPC B41J 2/195; B41J 2/1652; B41J 2/17546; B41J 29/393; B41J 2002/16573; B41J 2029/3935

(57) ABSTRACT

To mitigate the effects of ink lot variability in a print system, a server will monitor and analyze test pattern scan data to print devices that are exhibiting common test pattern quality issues while using a common batch of ink. When the server identifies that a particular batch of ink is causing issues that exceed a threshold deviation from a norm in at least a threshold number of print devices, the server will cause the print devices to take action that avoids use of the particular batch of ink and/or helps reduce print quality issues that the ink may cause.

### BACKGROUND

Inkjet printers use printheads that have an arrangement of nozzles that eject ink onto a substrate. An inkjet printer forms an image by selectively ejecting ink drops from the printhead nozzles, also referred to as jets or inkjets, onto an image receiving surface. In a direct inkjet printer, the printheads eject ink drops directly onto the surface of a print medium such as a paper sheet or a continuous paper web. In an indirect inkjet printer, the printheads eject ink drops onto the surface of an intermediate image receiving member such as a rotating imaging drum or belt.

During printing, the printheads and the image receiving surface move relative to one other, and the inkjets eject ink drops at appropriate times to form an ink image on the image receiving surface. A controller in the printer generates electrical signals, also known as firing signals, at predetermined times to activate individual inkjets in the printer.

The ink ejected from the inkjets can be liquid ink that is stored in containers installed in the printer. Alternatively, some inkjet printers use phase change inks that are loaded in a solid form and delivered to a melting device that heats and melts the solid phase change ink to a liquid form that is supplied to a printhead for printing as liquid drops onto the image receiving surface.

In the field of inkjet printing, even minor deviations in ink formulation and/or small levels of contaminants in an ink batch can cause substantial variations in printer performance between ink batches. Minor inconsistencies in ink composition can cause the ink to dry or coagulate within the printhead nozzles. This leads to unacceptable print quality, as even a partial clog in a printhead nozzle can cause the ink to be ejected from the nozzle at an angle that is other than the desired straight line.

While many printers have a purge operation available in which ink can be purged through the printheads to help remove contaminants, the purge process is not always effective when the ink itself is causing the issue, such as if one or more components of the ink fall out of solution and adhere to the ink delivery hardware in the printhead. Ink composition variability, and in particular an ink batch that has contaminants in it, or that has other quality issues, can lead to off axis jetting or other conditions that cause light or dark streaks in images printed by the printhead.

This document describes improvements that address at least some of the issues described above.

### SUMMARY

In some embodiments described in this document, a method of identifying a batch of printer ink that may cause print quality degradation includes by a processor that is communicatively connected to a plurality of print devices via one or more communication networks, receiving, from the plurality of print devices, operating data for the plurality of print devices over a time period, along with batch IDs for ink batches used by the print devices over the time period. The processor will store the operating data and the batch IDs for the ink batches in a data store. The processor will analyze the operating data and the batch IDs to identify deviations from a norm in the operating data. Upon identifying that the operating data associated with a particular batch ID includes deviations from the norm that exceed a threshold deviation in at least a threshold number of print devices, the processor will generate instructions to implement an action associated with the particular batch ID, and the processor will deploy the instructions to the print devices. Various embodiments also relate to a system configured to implement these method described above.

In some embodiments described in this document, a print device includes an ink supply system, a printhead that is fluidly connected to the ink supply system to receive ink from an ink container of the ink supply system, a scanner, and a control system. The control system includes a processor and programming instructions that are configured to cause the processor to, in response to detecting that the ink container has been placed into the ink supply system, send a code that is associated with the ink container to a server. In response to sending the code, and if the print device receives a message from the server indicating that a batch of ink in the ink container is causing print defects, the processor will output an alert. Otherwise, the processor will cause the printhead to engage in normal operations. As part of the normal operations, the printhead will print a test pattern on a substrate. The scanner will scan the test pattern as printed on the substrate and generate scan data for the test pattern. The processor will send the scan data to the server.

In some embodiments described in this document, a method and system for identifying a batch of printer ink that may cause print quality degradation are described. In this, a processor that is communicatively connected to a plurality of print devices via one or more communication networks implements a method that includes receiving, from the plurality of print devices, operating data for the plurality of print devices over a time period, along with batch IDs for ink batches used by the print devices over the time period. For a group of the print devices that are using a particular ink batch at a point in time, the processor will: (a) send a plurality of print settings to the group of print devices so that the print settings are varied among the print devices of the group; (b) receive scan data from the group of print devices, wherein the scan data includes information for test patterns printed by the group of print devices using the particular batch of ink and the varied print settings; (c) select, from the varied print settings, one of the print settings for which the scan data exhibits x dot placement (xdp) rise that is relatively lower than that of at least some of the other scan data; and (d) send the selected print settings to the group of print devices for use in print operations.

### BRIEF DESCRIPTION OF THE DRAWINGS

FIG. 1 is a block diagram that depicts elements of an ink delivery system, such as one that may appear in the prior art.

FIG. 2 depicts example elements of a printhead.

FIG. 3 illustrates an example fleet of print devices, along with a server that receives data from the print devices and uses the data to identify ink batch issues.

FIGS. 4A and 4B provide a flow diagram illustrating actions that a print device may implement in various methods described in this document.

FIG. 5 illustrates a process of receiving information from a barcode or transmitter of an ink container.

FIG. 6A illustrates an example test pattern printed by a printhead assembly in which the nozzles are relatively clean and not contaminated due to ink batch quality issues. FIG. 6B illustrates an example test pattern printed by a printhead assembly that has contamination adhered to the edges of the nozzles.

FIG. 7 is a flow diagram illustrating actions that a server may implement in the after receiving data described in FIG. 4 from multiple print devices.

FIG. 8 illustrates an example set of data captured by a fleet of print devices, and timing of maintenance actions taken in response to different analyses of that data.

FIG. 9 illustrates an example method by which the server may select actions that print devices may implement for particular ink batches.

FIG. 10 illustrates components of an example multi-function print device.

### DETAILED DESCRIPTION

In the various embodiments, the devices, methods and systems of the present disclosure relate to ink delivery systems of printers that include printheads. Specifically, the present disclosure relates to printheads and ink delivery systems, and methods of operating such systems to address drop directionality degradation caused by minor ink composition differences across various batches of ink, such as those that may result from small levels of contaminants in particular batches of ink used by the systems.

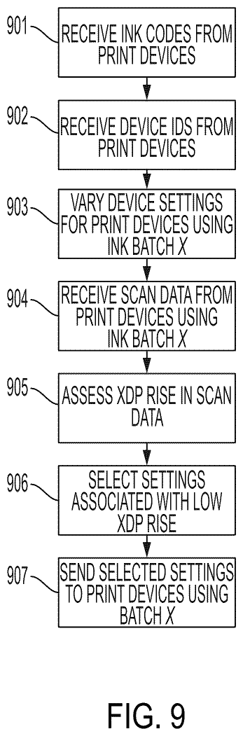

As discussed in this document, the term ink delivery system refers to the elements of a printer that deliver inks to a substrate, including the printhead(s) and components that deliver ink to the printhead(s). A printer may include an outer housing that stores the ink delivery system and includes a user interface which allows a user to interact with the system. Color printers typically have multiple printheads. As housings and user interfaces of printers are well known, the present disclosure mainly focuses on ink delivery systems and other components of the print devices that are relevant to the discussion in this document. Additional elements of a print device will be described in the context of FIG. 9.

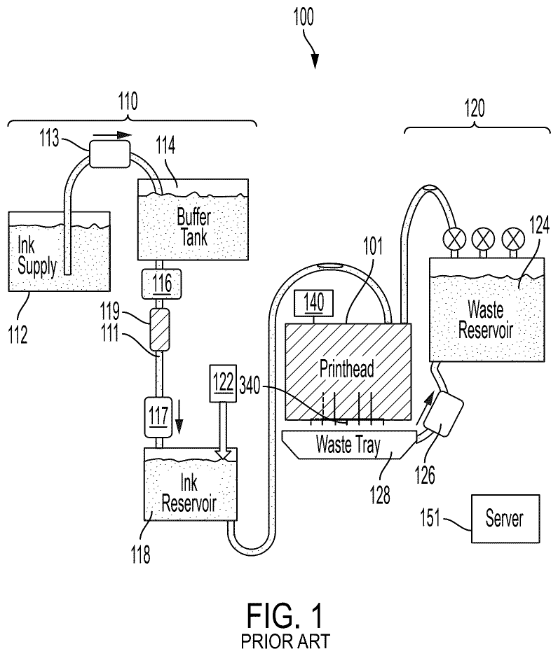

Referring to FIG. 1, elements of a print engine of a prior art ink delivery system 100 are depicted. The print engine includes a printhead 101, an ink supply system 110, and a waste system 120. The printhead 101 may include hundreds, and in some cases thousands, of small nozzles that are responsible for ejecting ink and creating images on the surface of a medium. The ink supply system 110 provides ink from one or more ink sources to the printhead 101. The waste system 120 manages and removes excess ink, debris and contaminants from the printhead 101.

The ink delivery system 100 also includes a control system 140. The control system 140 includes one or more microcontrollers or processors with embedded software and/or a memory containing programming instructions that is configured to enable the control system 140 to control the operations of the ink delivery system 100 and its components, including printhead 101. As shown, the control system 140 is illustrated as being located onboard the ink delivery system 100, and in particular as being a controller that is focused control of the printhead 101. However, in some configurations, the control system 140 also may include one or more processors, memory devices, and programming instructions that are located elsewhere in the ink delivery system 100 and/or offboard the ink delivery system 100, and that are in systems that are communicatively connected to the print engine of the ink delivery system 100 via one or more communication paths.

The ink supply system 110 includes an ink supply 112, a buffer tank 114, a filter 116 and degasser 119, and an ink reservoir 118. The ink supply system 110 additionally includes a first ink supply pump 113 and a second ink supply pump 117. The first ink supply pump 113 is positioned in a conduit between the ink supply 112 and buffer tank 114, and during operation it is configured to draw and transport ink from the ink supply 112 to the buffer tank 114. The second ink supply pump 117 is positioned in a conduit 111 between buffer tank 114 and the ink reservoir 118, and it is positioned to draw and transport ink from the buffer tank 114, through the filter 116 and degasser 119, to the ink reservoir 118.

In some configurations, the buffer tank 114 is the main ink source during use of the ink delivery system 100. It holds ink that is available for immediate use by the printhead 101. In some embodiments, the buffer tank 114 includes separate containers which hold different ink colors. Similarly, multiple ink supplies 112 of different colors may be provided, and multiple ink reservoir 118 compartments may be included. To simplify the system, a single conduit and a single pump are depicted as fluidly interconnecting these elements. However, in practice multiple branches may connect these elements.

As discussed above, the buffer tank 114 is fluidly attached to a filter 116 and/or degasser 119 that are positioned to filter and degas the ink before the ink reaches the ink reservoir 118. As depicted, the filter 116 and degasser 119 are arranged prior to (i.e., upstream of) fluid traveling through the second ink supply pump 117 and various branches 20. It will be appreciated that the filter 116 and degasser 119 may be positioned at other locations in the conduit, such as after (i.e., downstream of) the second ink supply pump 117. The filter 116 is configured to remove impurities from the ink prior to the ink reaching ink reservoir 118 and the printhead 101. The filter 116 may be a membrane filter, a fibrous filter, a mesh filter, or a different type of appropriate filter for removing impurities. In some embodiments, the degasser 119 may be configured as a membrane that allows air particles to be pulled through while routing the ink towards the ink reservoir 118. The degasser 119 may also remove other dissolved gases or undissolved gases from the ink prior to the ink reaching the printhead 101. As discussed above, the degasser 119 may be a membrane degasser in some embodiments. In other embodiments, the degasser 119 may also be a vacuum degasser, an ultrasonic degasser, or other degasser.

The ink moves fluidly through the ink delivery system 110 through the second ink supply pump 117. The second ink supply pump 117 fills the ink reservoir 118. The top of the volume of ink in reservoir 118 is positioned below the face of the printhead 101, thus applying a negative pressure at the print head nozzles. In some embodiments, one or more of the ink supply pumps (such as second ink supply pump 117) may be a peristaltic pump. Other types of pumps, such as diaphragm pumps, piston pumps, rotary lobe pumps, or a other pump types may be used.

A negative pressure is required to form a meniscus (e.g., a curved surface of liquid ink at the opening of the printhead) in the nozzle, which prevents the nozzles from drooling ink during normal operation. In some embodiments, one or more of the ink supply pumps (such as second ink supply pump 117) may be a peristaltic pump.

In the example configuration shown in FIG. 1, the second ink supply pump 117 is positioned at an elevation that is lower than that of the buffer tank 114. The ink reservoir 118 is positioned at an elevation that is lower than that of the buffer tank 114 and the second ink supply pump 117. With this configuration, gravity helps to pull ink from the buffer tank 114 towards the second ink supply pump 117 and the ink reservoir 118.

The ink reservoir 118 is additionally attached to a purge pump 122. The purge pump 122 allows for pressure to be placed on the ink in the ink reservoir. This pressure causes ink to flow through the printhead, removing contaminants. Additionally, the purge pump 122 may cause initial ink flow from the reservoir 118 to the printhead 101. The printhead 101 includes ink nozzles that through which the printhead 101 ejects droplets of ink. The ink is periodically pushed through the nozzles using the purge pump 122 to clear contaminants or to prepare the nozzles for printing. The purged ink will enter a waste tray 128, from which a pump 126 may draw the waste ink and direct the waste ink to a waste ink reservoir 124. This purge process can help extend the life of the ink delivery system 100 and help to prevent clogs in the printhead 101.

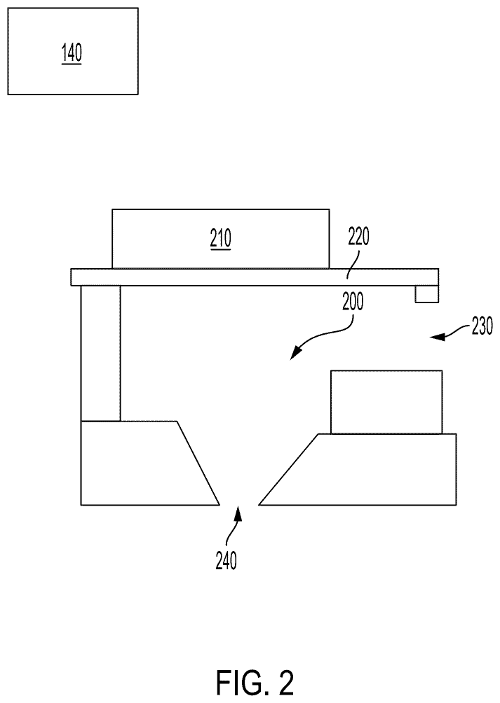

In some configurations, the printhead 101 may be a piezoelectric printhead. Referring to FIG. 2, example elements associated with an ink chamber 200 of such a printhead 101 are shown. The ink chamber 200 includes one or more piezoelectric elements 210 attached to a diaphragm 220. Ink flows into the chamber at an inlet 330 and out of the chamber through a nozzle 240. The piezoelectric element 210 changes shape or size when an electric current is applied to it. During operation, the control system 140 (which also appeared in FIG. 1) causes a voltage to be applied to the piezoelectric material causing the piezoelectric element 210 to deform. Each cycle of the voltage waveform will cause the piezoelectric material to expand and eject the ink, and then contract to immediately refill the chamber. The deformation causes pressure to build on the diaphragm 220 and within the ink chamber 200. This causes ink, in a controlled and precise manner, to be ejected from the nozzle 240 under a controlled pressure.

Many print devices employ multiple printheads. For example, a typical printer may include at least three separate printheads.

Returning to FIG. 1, the print device's control system 140 may be communicatively connected to server 151 of FIG. 1. The server may be one that is located on a network of which the print device is a part. Alternatively, the server may be external to the print device's local network, and instead able to receive messages from and send messages to the print device via a communication network such as the internet.

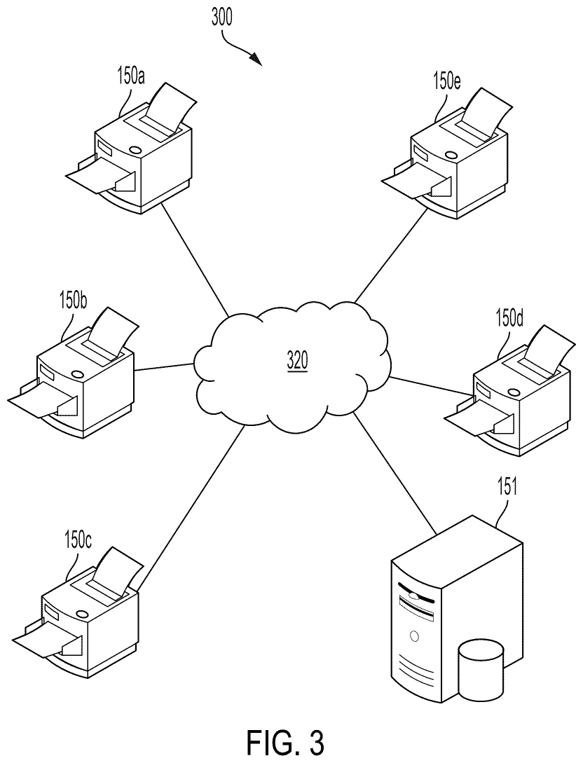

FIG. 3 shows an example fleet 300 of print devices 150a-e, and a server 151 that receives data from the print devices and uses the data to identify ink batch issues according to procedures described in this document. The fleet 300 can be any size, from a single print device to hundreds, thousands, or even more. As shown, the fleet 300 includes multiple print devices 150a-e that are in operational use, e.g., supporting a printing enterprise, and are communicatively connected through network 320. FIG. 3 also shows a server 151 which is communicatively coupled to the print devices 100 and is configured to operate as an analysis system process information received from the fleet 300 to discover and take action to mitigate issues such as those described below. In some examples, the fleet 300 goes beyond print devices in current operational use by an enterprise. That is, analysis system server 151 may process calibration information associated with print devices 150a-e across multiple enterprises and/or print devices 150a-e that may not be currently in operational use. In some aspects, analysis system server 151 may process historical information, e.g., to identify trends over a time period, and/or analysis system server 151 may process cross-enterprise information to detect differences between installations. In some examples, analysis system server 151 is associated with a manufacturer or supplier of the print devices 150a-e, a manufacturer or supplier of consumables used by the print devices 150a-e, or a service that maintains and/or operates the print devices 150a-e.

The present disclosure relates to methods and systems for addressing ink batch issues in printing systems. As a printer operates over a time period, it will use multiple batches of ink. Even minor deviations in composition between ink batches can cause substantial variations in printer performance. Minor inconsistencies in ink composition can cause the ink to dry or coagulate within the printhead nozzles. Contaminants or other issues in a batch of ink can also cause issues with printhead operation. This leads to unacceptable print quality, as even a partial clog in a printhead nozzle can cause the ink to be ejected from the nozzle at an angle that is other than the desired straight line. This can lead to blurry images, light or dark streaks in images printed by the printhead, or other consequences, all of which require maintenance and/or replacement of the printhead.

To mitigate the challenges described above, the methods and systems of this disclosure use a process in which a server collects data from multiple print devices and uses the data to detect when a problem exists in a particular batch of ink that has been deployed to at least some of the devices.

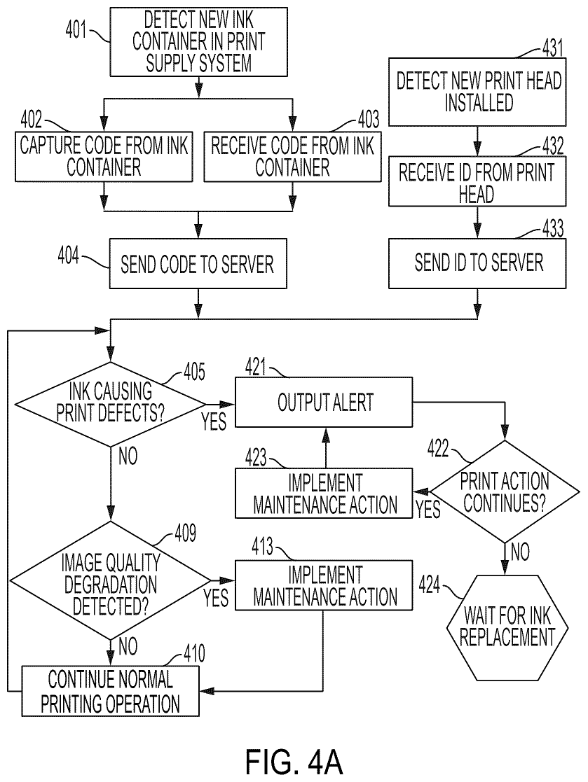

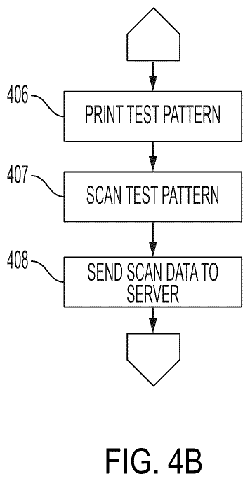

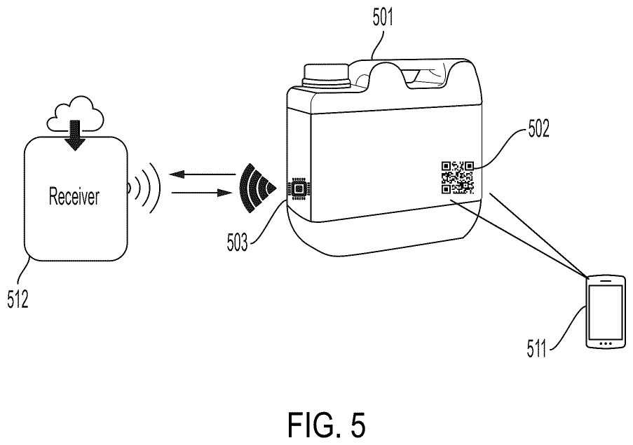

FIGS. 4A and 4B (collectively referred to in this document as FIG. 4) illustrate example steps that a print device may implement in this process. In this, a processor that is associated with a control system of a print device may receive a code from an ink container that is or will be inserted into the print device. The processor many receive this code in one of several ways. For example, and with reference to FIGS. 4 and 5:

At 401 a controller of the print device may detect that a new ink container 501, such as an ink cartridge, is or will be inserted into the ink supply system. The system may detect this by one or more sensors returning a signal that an ink container was removed and replaced, by detecting that an ink container is empty and needs to be replaced, by receiving a user input, or by other means.

The print device will receive a unique identifying code that is associated with the container, with the ink batch that is in the container, or both. The identifying code can be used to identify the container (and/or the ink batch that is in the container) in later steps. For example, if the print device is equipped with a camera that can capture an image of the ink container, then at 402 the camera may capture an image of an identifying code 502 such as a barcode, serial number or other code that is attached to the container and includes a unique code associated with the container, and the print device may process the image to extract the code 502 from the image. Alternatively, at 402 the print device may output a message that prompts a user to use a camera of an electronic device 511 to capture an image of the code 502 that is attached to the container, and the control system or a scanning application of the electronic device 511 may process the image to extract information from the code 502. Alternatively, at 403 the print device may receive the unique code 502 from the ink container via another input method, such as by receiving the code as input by an operator via a user interface.

If the ink container code is embedded or stored in an electronic device 503 that is affixed to the container, such as a radio frequency identification (RFID) tag, a Bluetooth or near field communication (NFC) transmitter, or other device, then instead of step 402, at 403 a wireless communication receiver 512 of the print device may receive the code as transmitted by the RFID tag, a transmitter, or other device of the device 503 that is attached to the ink container.

After the controller receives the code from the ink container, at 404 the controller will send the code to a server, such as server 151 of FIGS. 1 and 3. The server may be one that is located on a network of which the print device is a part. Alternatively, the server may be external to the print device's local network, where it is able to receive messages from and send messages to the print device via a communication network such as the internet.

In some circumstances, the server may have identified a particular batch of ink as requiring action by print devices before using the ink in printing operations. Methods by which the server may do this will be described later in this document. If so, the server will send the print device a message indicating that the batch of ink has been designated as causing image quality issues (i.e., print defects), such as by sending a “do not use this ink” message, by sending a notice of defect, by sending a message to change a setting or implement some other action in one or more printer operations, or some other warning. For example, if the print device receives a message that the ink has been designated as causing print defects (405: YES), then at 421 the print device may output an alert indicating that service is needed. The alert may be an indicator displayed on a user interface of the printer, an audible alert, and/or a message that is sent to an administrator who is handles maintenance of the print device. If the print device continues to be used despite the alert (422: YES), then at 423 the print device may implement a maintenance action, such as increasing a purge frequency of one or more of the printheads, taking a particular purge action in response to the alert, taking other actions which will be described below, or even (if the ink batch is designated as being defective and not for use) stopping print jobs from being printed until corrective action is taken. Otherwise (422: NO), then at 424 the print device may wait for the defective batch of ink to be replaced, and it may resume normal operation with step 401 after that.

If the print device does not receive a message indicating that an alert has already been associated with the ink batch (405: NO), then the printhead may proceed with normal printing operations at 410.

Referring to FIG. 4B, at various points in time during operation, 406 the print device will print a test pattern. This may happen periodically, based on a determined schedule such as after printing a certain number of sheets. In addition or alternatively, the printer may print a test pattern in response to receiving a command via a user interface or from an external server. This could happen at various points in the process after a printhead is installed, such as before or after step 405 of FIG. 4A, at any time during normal printing operation (step 410 of FIG. 4A), or after performing a purge or other maintenance action (step 413 of FIG. 4A).

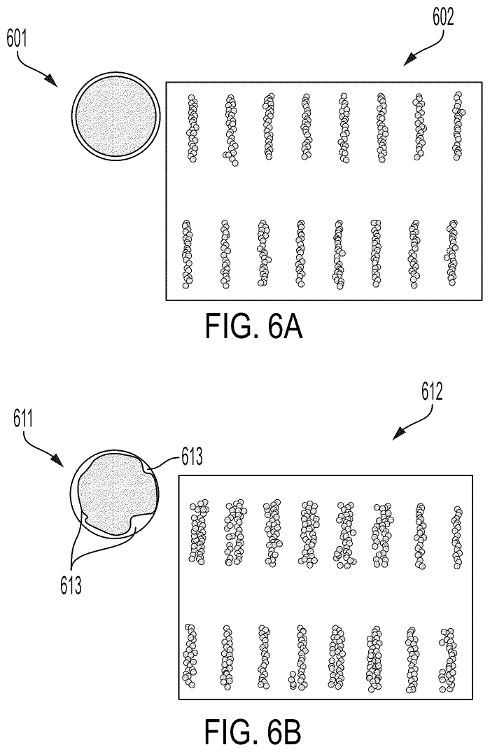

FIG. 6A illustrates an example test pattern 602 of evenly spaced lines of a single color generated by a printhead assembly that is not experiencing print quality degradation due to ink composition issues. A magnified image of a nozzle 601 from the uncontaminated printhead also appears in FIG. 6A. Each line in test pattern 602 is a series of printed dots, each of which results from a drop of ink from nozzle 601. In this case, the ink batch used to print the lines does not appear to be causing any issues in the nozzle 601. Instead, the lines of test pattern 602 appear to be relatively uniform and sharp.

However, FIG. 6B illustrates an example single-color test pattern 612 generated by a printhead assembly in which a nozzle 611 of the printhead used to print the color of the test pattern experienced contamination. The nozzle 611 is partially obstructed by contamination 613, which causes ink drops ejected from the nozzle 611 to deviate from their desired circular form. This causes the lines of test pattern 612 to appear blurry.

The test patterns shown in FIGS. 6A and 6B are examples. Other test patterns, such as grids of dots, or other patterns, may be used.

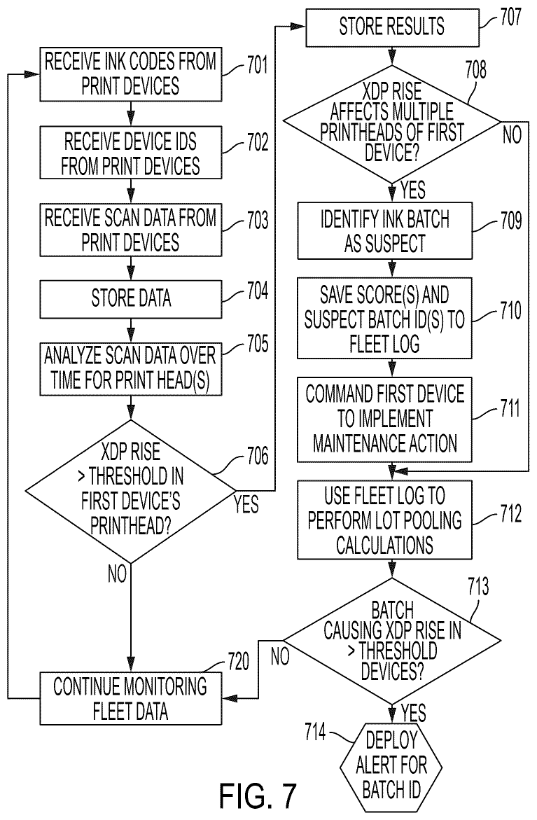

A blurry test pattern could be caused by a defective batch of ink, or it could be caused by other issues. Accordingly, returning to FIG. 4B, after printing the test pattern at 406, a scanner of the print device will scan the test pattern at 407. At 408 the print device will send the scan data to the server for further analysis, which will be described below. The scan data may be the actual scanned image and or data extracted from the scanned image, such as measurements that will be described below in the discussion of FIG. 7.

The server will analyze the scan data from the print device, along with other scan data from other print devices, over a period of time. A process by which the server may do this will be described in FIG. 7 below. Returning to FIG. 4A, at any point in time, if the server returns a message indicating that the ink is causing image quality degradation and should not be used (405: YES), the print device implements the process of outputting an alert (step 421) and potentially implementing a maintenance action (step 42) as described above. Otherwise, the print device will begin or return to normal printing operations at 410 and continue those operations until a message is received indicating that the ink is defective and should no longer be used (step 405), image quality degradation is detected (step 409), or the process restarts because new ink has been placed in the ink supply at 401.

In addition, if at any point the print device or the server determines that image quality is degradation is detected in the print device (409: YES), but the degradation has not yet been associated with a particular ink batch, the printer may implement, or the server may send the print device a message with an instruction to implement, maintenance. If the print device determines or receives an order to implement maintenance due to image quality degradation (409: YES), then at 413 the print device may implement a maintenance action, such as increasing a purge frequency of one or more of the printheads, adjusting one or more prefire settings in the printhead, or stopping print jobs from being printed until corrective action is taken. After implementing the maintenance action, the print device may print and scan an additional test pattern (steps 406-408), and/or return to normal operation at 410.

At some point in the process described above, at 431 the print device will also detect that a new printhead is installed, and the print device will receive an ID of the printhead at 432. This may be done by a mechanical sensor in the device that detects removal and replacement of a printhead, by a transceiver that receives a new printhead ID from a transmitter or other electronic device of the printhead, by reading the information from a chip that is on or on the print head, or by a combination of any of these or other processes. The print device will also transmit the printhead ID to the server at 433 so that the server can correlate scan data with particular printheads. Although FIG. 4 illustrates the transmission of the printhead ID as happening before step 405, in practice it could occur at any point after the printhead is installed (at step 431) and before step 409.

FIG. 7 illustrates actions that a server may implement when it receives the scan data described in the discussion of FIG. 4 from multiple print devices. As the print devices operate and ink batches are inserted into the print devices'ink supply systems, at 701 the server will receive the ink batch codes for those ink batches. At 702 the server will also receive identifiers for the print devices, such as the printhead IDs that are fluidly connected to the ink batches, so that the server can associate printheads with batch IDs and know which print devices—and which individual printheads of those devices-are printing a particular batch of ink.

The sever will also receive operating data from each of the print devices, and it will analyze that data to identify deviations from a norm in that operating data that may be associated with individual batches of ink. For example, at 703 the server may receive scan data from each of the devices. The scan data may be data collected by the print devices using the processes discussed above for FIG. 4, and it may include actual scanned images, or data taken from the print devices'analysis of the images.

At 704 the system will store the ink codes, printhead IDs, and scan data in one or more data stores, such as a fleet log, with timestamps so that the system can later review stored data to identify what batches of ink were (or are) being used by particular printhead when printing a particular test pattern at any given point in time. For example, a scan of a cyan-colored test pattern may be associated with the cyan printhead of a particular print device. In some situations, the association may be received because the print device provided it. Alternatively, the system may store printhead IDs and batch IDs in a data store, and when the system receives scan data for an image formed by a particular printhead or a scan of a particular color printed by a print device at a given point in time, the system may look that print device and/or printhead up in the data store and retrieve the batch ID for the ink that the printhead used to print the image.

At 705 the server will analyze the scan data to determine the amount of deviation of actual x dot placement (xdp) or y dot placement (ydp) data in the scan from its expected target xdp or ydp (i.e., deviations from expected an expected location in x, y coordinates). For simplicity, in the remainder of this discussion and in the claims, we will refer to xdp. However, all such references are intended to cover situations in which xdp, ydp, or both are analyzed. The analysis may include measuring the xdp if the scan data is the image itself. Otherwise, if the print device processed the image and sent xdp measurements to the server, the analysis may include reviewing the xdp measurements that are in the scan data as received from the print device. Optionally, the system may do this as scans data arrives. Alternatively, the system may store scan data and analyze it for each printhead after a period of time has elapsed, or after or number of scans have been analyzed for test patterns printed by any given printhead.

To measure xdp, the server and/or print device may align a best fit grid with the dashes that appear in the image. Then, the system may concurrently measure xdp for all nozzles of a printhead as the distance from the dash to the best fit (reference nozzle location) in the grid. The xdp value that the system considers may be a standard deviation of all xdp values, rather than a specific measured value. A printer that prints with “perfect” xdp would be expected to be uniform, such as in a perfect grid pattern. However, even the best print devices will typically print images that have at least some amount of xdp rise (i.e., deviation from the best fit locations).

The server may measure xdp rise in a scanned image by any suitable image processing algorithm, such as those described in U.S. Patent Application Publication Number 2011/0242187, which is incorporated into this document by reference and describes methods of locating the center of each dash (and thus the centers of the dots that make up the dash). For example, if the test patterns each comprise a matrix of printed lines such as the test patterns 602 and 612 of FIGS. 6A and 6B, the processor may process the image to identify the center point of each printed line. If scanning resolution permits the processor may identify center points of individual dots that make up the printed lines. The positions of each center point are then compared to a set of reference data that includes the ideal or expected locations for the center points if the dots were printed precisely in their target locations to determine the deviation of the center points from their target locations in the reference data.

If the server measured the xdp value, at 704 the server will add the xdp information to the data store that contains other xdp measurements.

As the server analyzes the scan data at 705, it may look for data that reveals any printheads with an xdp rise that deviates from a norm by at least a threshold amount. For example, if a test pattern is a set of lines such as those in FIGS. 6A and 6B, the system may identify xdp locations of one or more center points in each of the printed lines. The system may then identify distances between the xdp locations of the one or more center points and the reference (i.e., target) xdp locations and add those distances to the fleet data log in the data store. In this case, deviations from the norm would be those in which the identified distances have increased by at least a threshold amount as compared to past data captured over a time period.

At 706, as scan data is received and logged from multiple devices, the server will analyze the data to determine whether the xdp rise for any given device is greater than a threshold amount. In FIG. 7, references to a “first device” refer to any given print device. To measure xdp rise, the server may first use median filtering or another noise reduction method to reject xdp measurement outliers, which can commonly appear in a data set. The server may then perform additional smoothing and interpolation of the data using Gaussian Progress regression or another suitable method, which can convert the individual data points into an analog data set. The system may then look for any time segment containing a minimum delta in xdp (such as >4 μm) and a minimum xdp rate of change (such as 1.5 μ/week). The system may assign a score to ink containers in the time segment (and slightly before that time function), where the score is a function of the measured xdp change and the xdp rate of change and indicates a measurement of xdp variation rise. The threshold may be a particular score, or a function of the score.

If the server determines that there has not been an xdp rise that is greater than a threshold amount in a first device's printhead (706: NO), then the server will simply continue to monitor scan data for other print devices in the fleet, as well as from new scans from the same device. However, if an xdp rise was greater than a threshold amount in the first device's printhead (706: YES), then at 707 the server will store the results by adding the score (as determined above) and the ink batch ID to a one or more logs of data for all print devices in the fleet that the server is monitoring. Optionally, the system may log this data for a particular period of time, such as 60 days, after which time it may discard or archive the data. The system may identify the ink batch of that in batch ID as suspect of causing print quality at 709.

In addition, and optionally, if the xdp rise measured in a print device's scan data affects (i.e., is found in) more than one printhead in the device (708: YES), at 709 the server may identify the ink batch that was used by those printheads as being suspect. The system will save the scores and ink batch ID for the suspect batch to a fleet log at 710. At 711 the server may send an instruction to the first device to implement a maintenance action, such as to increase the frequency of a purge process that is applied to those a particular ink color in those printheads.

At 712, the server will then use the fleet logs to perform calculations on the data that we may refer to as lot pooling calculations or batch pooling operations. For example, to identify which a batch of ink of multiple suspect batches of ink are causing an image quality issue, the system may employ lot pooling calculations that look for commonalities in the data for any given ink batch that show that the batch consistently causes image quality issues. For example, if a test pattern is a set of lines such as those in FIGS. 6A and 6B, image quality issues would occur in those scans in which the identified distances have increased by at least a threshold amount as compared to past data captured over a time period. To determine whether deviations persist in a batch of ink rather than just an individual print device, the system may consider the scores for all of the ink containers of a batch that have been reported. To be considered an ink that could cause image quality issues, the system may require one more rules, such as (1) a minimum number of print devices using the ink must have reported scan data with image quality issues, (2) a minimum percentage of the print device that used ink from that batch must have at least one container from that ink lot suspected of causing image quality issues, (3) a minimum number of containers from that ink batch must have suspected of causing image quality issues, and/or (4) a minimum percentage bottles of containers from that ink batch must be suspected of causing ink quality issues. The score associated with that ink batch may be a function of the score from each print device, such as the median of the root mean square score as determined from data from each print device.

If the lot pooling calculations indicate that a particular batch of ink is causing xdp rise in at least a threshold number of devices (713: YES), the server may deploy an alert message to the fleet of printers that instructs the printers to take action before using ink from that batch (step 714). Each print device may then act on the alert message for the ink batch using the processes described above in the context of FIG. 4. Otherwise (713: NO), the server will continue to monitor data for the fleet of print devices by receiving and processing ink batch and scan data as described above.

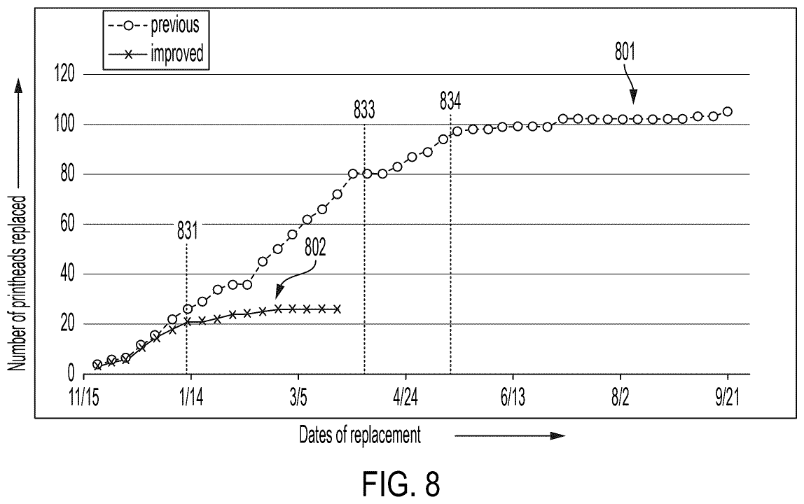

FIG. 8 illustrates an example data set shown in which line 801 represents the number of printheads that had to be replaced in a fleet of print devices over a period of time without the methods described in this document. Line 802 represents a set of printhead replacement data for the fleet of print devices while using a simulation of the methods described in the discussion of FIGS. 4 and 7. Each data point on lines 801 and 802 indicate the number of printheads replaced in the fleet as of that date due to print quality issues. Each data set starts on November 14.

In the first data set, on January 12 (represented by line 831) technical personnel monitoring the fleet of print devices noticed that the rate of cyan printhead replacement in the devices was rising. Line 801 shows that cyan printheads continued to require replacement manual investigation of the devices identified the ink lot issue on April 5 (represented by line 833). The investigation took several weeks because it required many data gathering and analysis activities. The xdp deviation continued to rise for several weeks because of existing damage caused by the ink batch issue, and xdp deviation did not level off until after several weeks after that (represented by line 834).

In contrast, line 802 indicates that a server, using the processes described in this document, could have noticed the defective ink issue on or before January 12 and associated the printhead replacements with an unusual rise in xdp deviation in test patterns for a particular batch of cyan ink in the fleet. The server could have then issued a command to stop using that ink on January 12, which would have quickly stopped (or at least reduced) the abnormal rise in cyan printhead replacement.

The system also may use the methods described in this document to cause print devices to take actions that are tailored to improve print quality for a particular ink batch. This is illustrated in FIG. 9. The process illustrated in FIG. 9 may be implemented as a possible maintenance action by devices after image quality degradation is detected in a batch of ink. This may allow the system to determine whether different print settings will resolve the issue, before ordering the ink batch to be replaced. The process illustrated in FIG. 9 also may be implemented at other times, such as in a preventive action to implement when a new ink batch is being deployed. Like the process illustrated in FIG. 7, in FIG. 9 at 901 the server will receive ink batch codes for ink batches that various print devices are using, and at 902 the system may receive identifiers for the print devices, such as the printhead IDs.

At 903 for any given batch of ink (which in this discussion we may refer to as ink batch X), the server will determine print device settings for various of the print devices that are using ink batch X. The server may do this by retrieving the settings from the print devices, by generating settings and sending them to the print devices to implement, or a combination of the two. In step 903, the server will ensure that the settings are varied among the print devices so that the system can assess image quality of documents printed by the devices with different settings. This may occur by randomly generating different settings, or by causing at least one print device to change its settings after finding that multiple print devices are using the same settings.

The settings that may be set or changed in step 903 may include, for example, prefire settings for printheads that print ink batch X. Prefiring is a process in which ink is then moved back and forth in the nozzles while the printhead is in the print position. The prefire settings that may be changed include, for example, frequency of prefiring, number of pulses of the prefire operation, firing pattern, waveform shape, pulse width, rest length, and/or other settings such as voltage applied to piezeoelectric elements of the printhead nozzles during prefiring.

After the print devices that are using ink batch X implement their assigned settings, the printers will use ink batch X to print and scan test patterns as described in FIG. 4B. At 904 the server will receive the scan data. At 905 the server will analyze the scan data, and in particular the server will look for scan data that shows a relatively low xdp rise (i.e., as compared to xdp rise in other test patterns).

At 906 the server will select the settings that were associated with the scan data exhibiting relatively low xdp rise. This does not necessarily need to be the absolute lowest xdp rise, as the system may consider other factors in the analysis as well. For example, the server could use a designed experiments methodology, or a different method, to select the xdp rise (and associated settings) in this step. At 907 the server will send the selected settings to all print devices that are using ink batch X, and the print devices will use those settings when using ink batch X when printing documents after that.

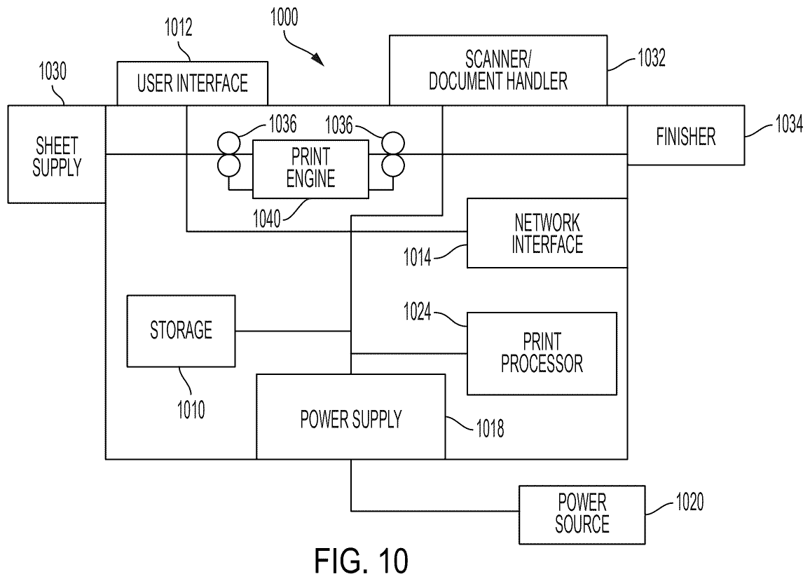

FIG. 10 illustrates components of an example multi-function print device 1000, which is an example of a print device as described elsewhere in this document and includes components such as those described in FIG. 1. MFD 1000 may also be embodied as, or incorporated in, a printer, copier, multi-function machine, or other device that includes the capability to print, scan, and/or copy a document, including an electronic document, on a physical printable and/or readable media, such as paper. MFD 1000 includes a print engine 1040 capable of printing markings on sheets of print media, a processor 1024 operatively coupled to the printing engine 1040, a user interface 1012 operatively coupled to the processor 1024, and a network interface 1014 operatively coupled to the processor 1024 and print engine 1040. Storage 1010 is a data store that is also operatively coupled to network interface 1014, processor 1024, and print engine 1040. Print engine 1040 is also operatively coupled to sheet supply 1030, document handler and/or scanner 1032, a media path 1036, and optionally a finisher 1034. Power supply 1018 receives input from a power source 1020 such as an external power outlet or a battery and provides power to components in MFD 1000 including a memory device designated as storage 1010, network interface 1014, processor 1024, and print engine 1040. Other elements may be included in MFD 1000 but are not described here in the interest of conciseness.

In some embodiments, processor 1024 or certain elements of it may be referred to as an image processor and may operate in a different manner than a general-purpose processor if it is specialized for processing image data. A printing mechanism is initiated by instructions in signals communicated from processor 1024 to print engine 1040. Media path 1036 is positioned to supply continuous media or sheets of a print media substrate (e.g., paper or cardstock) from sheet supply 1030 to the marking device(s) included in print engine 1040. After print engine 1040 generates and applies various markings to sheets of substrate, the sheets may optionally pass to finisher 1034 which can flip, fold, staple, sort, collate, cut, etc., the various printed sheets based on the additional information associated with printing the electronic document. In the embodiments of this disclosure, finisher 1034 may include a conveyor that directly conveys the printed substrates into the secure storage container. In addition or alternatively, finisher 1034 may include an output tray from which a human or a mechanical operator can lift the documents and move them to the container and/or bind the documents with a binding material.

MFD 1000 also includes scanner 1032 that includes a camera and a document handler with transport components (such as a conveyor or rollers) that will pass a document under the camera so that the camera may capture an image of the document. The scanner 1032 may receive and capture a digital image of each document sheet printed by the print engine 1040 so that the system can create an electronic record of each document sheet that the print engine 1040 prints. If the system receives a physical document from an external source, scanner 1032 also (or instead) may scan the document before printing a copy of the document.

Optionally, MFD 1000 may include a user interface 1012 that is configured to display one or more menus that may include selectable options and/or status reports for the print jobs to be printed, such as the alerts described in this document.

The following paragraphs provide additional information about various terms used in this document:

In this document, the term “approximately,” when used in connection with a numeric value, is intended to include values that are close to, but not exactly, the number. For example, in various embodiments, the term “approximately” may include values that are within +/−1% of the value, +/−5% of the value, +/−10 percent of the value, or any value or fraction thereof between any or all of the values.

The term “substantially,” when used in connection with a value, is intended to mean approximately, within a threshold tolerance that is a percentage corresponding to any of the percentages described in the previous paragraph. For example, items described as “substantially the same,” “substantially equal,” or “substantially planar,” may be exactly the same, equal, or planar, or may be the same, equal, or planar within acceptable variations that may occur, for example, due to manufacturing processes and/or tolerances.

The terms “printer” and “print device” refer to a machine having hardware capable of reading digital data and using the information from the data and associated print instructions to print a physical document on a substrate. In some embodiments, a print device may have additional capabilities such as scanning or faxing and thus may be a multifunction device. Example print devices include traditional printers and multifunction devices, as well as specialized print devices such as ticket printers, sales receipt printers, and the like. Components of a print device typically include a print engine, as well as a document feeding system configured to pass a substrate through the print device so that the printhead or printheads of the print engine can print characters and/or images on the substrate.

The term “print engine” refers to the marking hardware of a print device, such as a print head, along with marking material storage and delivery components such as a print cartridge containing ink, toner or another marking material. A print engine also includes conveyors, rollers or other media transport components that are configured to move a substrate past the print head to receive printed images onto the substrate. The print engine also may include a control system that controls operation of the hardware described above. In an inkjet printing system, the marking material storage and delivery components may include one or more print heads arranged in a print zone that eject ink drops onto the substrate.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

The terms “processor” and “controller” refer to electronic device hardware that is configured to execute programming instructions. The terms “processor” and “controller” may refer to either a single processor or controller, or to multiple processors or controllers that together implement various steps of a process. Unless the context specifically states that a single processor or controller is required or that multiple processors or controllers are required, the terms “processor” and “controller” include both the singular and plural embodiments.

The terms “memory,” “memory device,” “computer-readable medium” and “data store” each refer to a non-transitory device on which computer-readable data, programming instructions or both are stored. A “computer program product” combination of a memory device and the programming instructions stored in it. Unless the context specifically states that a single device is required or that multiple devices are required, the terms defined in this paragraph include both the singular and plural embodiments, as well as portions of such devices such as memory sectors.

A “server” is a computing device that includes one or more processors and one or more memory devices.

This disclosure is not limited to the particular systems, methodologies or protocols described, as these may vary. The terminology used in this description is for the purpose of describing the particular versions or embodiments only and is not intended to limit the scope.

It will be understood that various modifications may be made to the embodiments disclosed in this document. Likewise, the above disclosed methods may be performed according to an alternate sequence. Therefore, the above description should not be construed as limiting, but merely as examples of the various embodiments. Those skilled in the art will envision other modifications within the scope and spirit of the claims appended to this document.

1. A method of identifying a batch of printer ink that may cause print quality degradation, the method comprising, by a processor that is communicatively connected to a plurality of print devices via one or more communication networks:
receiving, from the plurality of print devices, operating data for the plurality of print devices over a time period, along with batch IDs for ink batches used by the print devices over the time period;
storing the operating data and the batch IDs for the ink batches in a data store;
analyzing the operating data and the batch IDs to identify deviations from a norm in the operating data; and
upon identifying that the operating data associated with a particular batch ID includes deviations from the norm that exceed a threshold deviation in at least a threshold number of print devices, generating instructions to implement an action associated with the particular batch ID, and deploying the instructions to the print devices.

2. The method of claim 1, wherein the instructions cause each of the print devices to increase a frequency of a purge process in any printhead that uses the ink associated with the particular batch ID until the ink associated with the particular batch ID is replaced in a print supply system for that printhead.

3. The method of claim 1, wherein:
the operating data comprises scan data from test patterns printed on substrates; and
the norm is a function of previously measured distances of measured x dot placement (xdp) locations from reference xdp locations in a plurality of previously analyzed test patterns.

4. The method of claim 3, wherein:
each of the test patterns comprises a matrix of printed lines;
analyzing the operating data comprises identifying xdp locations of one or more center points in each of the printed lines, and identifying distances between the xdp locations of the one or more center points and the reference xdp locations; and
deviations from the norm are those in which the identified distances have increased by at least a threshold amount.

5. The method of claim 3, further comprising:
upon identifying that the operating data from a particular print device includes deviations from the norm that exceed a threshold deviation in more than one printhead of the particular print device, generating and deploying to the particular print device an instruction to implement a maintenance action.

6. The method of claim 5, wherein the instruction to implement the maintenance action causes the particular print device to increase a frequency of a purge process in each of the printheads of the particular print device that are using ink from the batch that is associated with the particular batch ID.

7. The method of claim 1, wherein generating the instructions to implement the action associated with the particular batch ID and deploying the instructions to the print devices comprises, for a group of the print devices that are using ink of the particular batch ID:
sending a plurality of print settings to the group of print devices so that the plurality of print settings are varied among the print devices of the group;
receiving scan data from the group of print devices, wherein the scan data includes information for test patterns printed by the group of print devices using the particular batch of ink and the varied print settings;
selecting, from the varied print settings, one of the print settings for which the scan data exhibits x dot placement (xdp) rise that is relatively lower than that of at least some of the other scan data; and
sending the selected print settings to the group of print devices for use in print operations.

8. A system comprising:
a processor that is communicatively connected to a plurality of print devices via one or more communication networks: and
a memory device containing programming instructions that are configured to cause the processor to:
receive, from the plurality of print devices, operating data for the plurality of print devices over a time period, along with batch IDs for ink batches used by the print devices over the time period,
store the operating data and the batch IDs for the ink batches in a data store,
analyze the operating data and the batch IDs to identify deviations from a norm in the operating data, and
upon identifying that the operating data associated with a particular batch ID includes deviations from the norm that exceed a threshold deviation in at least a threshold number of print devices, generate instructions to implement an action associated with the particular batch ID, and deploy the instructions to implement the action to the print devices.

9. The system of claim 8, wherein the instructions to implement the action are further configured to cause each of the print devices to increase a frequency of a purge process in any printhead that uses the ink associated with the particular batch ID until the ink associated with the particular batch ID is replaced in a print supply system for that printhead.

10. The system of claim 8, wherein:
the operating data comprises scan data from test patterns printed on substrates; and
the norm is a function of previously measured distances of measured x dot placement (xdp) locations from reference xdp locations in a plurality of previously analyzed test patterns.

11. The system of claim 10, wherein:
each of the test patterns comprises a matrix of printed lines;
the instructions to analyze the operating data comprise instructions to identify xdp locations of one or more center points in each of the printed lines, and identify distances between the xdp locations of the one or more center points and the reference xdp locations; and
deviations from the norm are those in which the identified distances have increased by at least a threshold amount.

12. The system of claim 10, wherein the programming instructions are further configured to cause the processor to:
upon identifying that the operating data from a particular print device includes deviations from the norm that exceed a threshold deviation in more than one printhead of the particular print device, generate and deploy to the particular print device an instruction to implement a maintenance action.

13. The system of claim 12, wherein the instruction to implement the maintenance action is configured to causes the particular print device to increase a frequency of a purge process in each of the printheads of the particular print device that are using ink from the batch that is associated with the particular batch ID for which the operating data includes deviations from the norm that exceed the threshold deviation.

14. The system of claim 8, wherein programming instructions to generate the instructions to implement the action associated with the particular batch ID and deploy the instructions to the print devices comprises, for a group of the print devices that are using ink of the particular batch ID:
send a plurality of print settings to the group of print devices so that the plurality of print settings are varied among the print devices of the group;
receive scan data from the group of print devices, wherein the scan data includes information for test patterns printed by the group of print devices using the particular batch of ink and the varied print settings;
select, from the varied print settings, one of the print settings for which the scan data exhibits x dot placement (xdp) rise that is relatively lower than that of at least some of the other scan data; and
send the selected print settings to the group of print devices for use in print operations.

15. A print device, comprising:
an ink supply system;
a printhead that is fluidly connected to the ink supply system to receive ink from an ink container of the ink supply system;
a scanner; and
a control system comprising a processor and programming instructions that are configured to cause the processor to, in response to detecting that the ink container has been placed into the ink supply system:
send a code that is associated with the ink container to a server,
in response to sending the code:
if the print device receives a message from the server indicating that a batch of ink in the ink container is causing print defects, output an alert,
otherwise:
cause the printhead to engage in normal operations,
wherein the normal operations comprise:
cause the printhead to print a test pattern on a substrate,
cause the scanner to scan the test pattern as printed on the substrate and generate scan data for the test pattern, and
send the scan data to the server.

16. The print device of claim 15, wherein the programming instructions are also configured to cause the processor to send an ID for the printhead to the server.

17. The print device of claim 15, wherein the programming instructions are also configured to cause the processor to, when the print device receives the message from the server indicating that the batch of ink in the ink container is causing print defect:
in response to detecting that the print device is being used for a print action after outputting the alert, implement a maintenance action in the print device.

18. The print device of claim 17, wherein the programming instructions to implement the maintenance action comprise instructions to increase a frequency of a purge process in the printhead.

19. The print device of claim 15, further comprising additional programming instructions to, after sending the scan data to the server:
if the print device receives a message from the server indicating that a batch of ink in the ink container is causing print defects, implement a maintenance action,
otherwise permit the print device to be used for a print operation without implementing the maintenance action.

20. The print device of claim 15, wherein the maintenance action comprises changing prefire settings before a subsequent print operation.

21. The print device of claim 15, further comprising additional programming instructions to, after the control system has sent the scan data to the server and the print device has been used for additional printing operations:
after a purge process having been performed on the printhead,
cause the printhead to print a new test pattern on an additional substrate,
cause the scanner to scan the new test pattern as printed on the additional substrate and generate new scan data for the new test pattern, and
send the new scan data to the server.

22. A method of identifying a batch of printer ink that may cause print quality degradation, the method comprising, by a processor that is communicatively connected to a plurality of print devices via one or more communication networks:
receiving, from the plurality of print devices, operating data for the plurality of print devices over a time period, along with batch IDs for ink batches used by the print devices over the time period;
for a group of the print devices that are using a particular ink batch at a point in time:
sending a plurality of print settings to the group of print devices so that the print settings are varied among the print devices of the group,
receiving scan data from the group of print devices, wherein the scan data includes information for test patterns printed by the group of print devices using the particular batch of ink and the varied print settings,
selecting, from the varied print settings, one of the print settings for which the scan data exhibits x dot placement (xdp) rise that is relatively lower than that of at least some of the other scan data, and
sending the selected print settings to the group of print devices for use in print operations.

23. The method of claim 22, wherein the selected print settings comprise prefire settings.
